(19) United States
(12) Patent Application Publication
(10) Pub. No.: US 2007/0041030 A1
(43) Pub. Date: Feb. 22, 2007

(54) PHOTOGRAPHING APPARATUS

(75) Inventor: Toshiya KOJIMA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/462,784

(22) Filed: Aug. 7, 2006

(30) Foreign Application Priority Data
Aug. 17, 2005 (JP) P2005-236688

(51) Int. Cl. G06F 3/12

(52) U.S. Cl. 358/1.13; 358/302

(57) ABSTRACT

A photographing apparatus 1 comprises an imaging unit that obtains an image signal by a first imaging operation, a recording medium M that stores an image data corresponding to the image signal in a RAW file format, and a control unit that performs a development operation of the image data in the RAW file format that is stored on the recording medium, on the basis of a parameter having a photography condition, and converts the image data in the RAW file format to an image data in a standardized file format.

### BACKGROUND OF THE INVENTION

1. Field of the Invention

The present invention relates to a photographing apparatus, and in particular to a photographing apparatus to perform a development operation of an image data in RAW file format without using a personal computer.

2. Description of the Related Art

A digital camera that can store an image data in a RAW file format is proposed. An image corresponding to the image data in the RAW file format can be edited by appropriate software that is installed on a personal computer or similar device. Further, a high quality image without deterioration of image quality by compression can be obtained, compared to the case in which the image data in a standardized file format, such as the JPEG file format, is edited.

Japanese unexamined patent publication (KOKAI) No. 2003-289498 discloses a file that attaches an image data in the RAW file format and a self extract program that can develop the image data in the RAW file format with an arbitrary PC.

However, because the personal computer with the appropriate software installed is needed to perform the development operation of the image data in the RAW file format, it is not appropriate to use the image data in the RAW file format in the case that an immediate development operation is needed (or in the case that the image needs to be seen immediately) after the imaging operation under the condition where there is no personal computer.

When the image data in the RAW file format and the image data in the standardized file format are stored at the same time, taking into account the case in which it is necessary to see the image immediately after the imaging operation, a storage field of the recording medium is needlessly used (wasted), and the time required for saving is increased, so that a shutter chance may be missed.

### SUMMARY OF THE INVENTION

Therefore, an object of the present invention is to provide an apparatus that can perform a development operation of an image data in the RAW file format and that can convert the image data in the RAW file format to the standardized file format, without needlessly wasting a storage field of a recording medium, under the condition where there is no personal computer or similar device.

According to the present invention, a photographing apparatus comprises an imaging unit that obtains an image signal by a first imaging operation, a recording medium that stores an image data corresponding to the image signal in a RAW file format, and a control unit that performs a development operation of the image data in the RAW file format that is stored on the recording medium, on the basis of a parameter having a photography condition, and converts the image data in the RAW file format to an image data in a standardized file format.

### BRIEF DESCRIPTION OF THE DRAWINGS

The objects and advantages of the present invention will be better understood from the following description, with reference to the accompanying drawings in which:

FIG. 1 is a construction view of a photographing apparatus in the first embodiment;

FIG. 2 is a construction view that shows a process of a development operation of an image data in the RAW file format, in the first embodiment;

FIG. 3 is a construction view that shows a process of a development operation of a plurality of image data in the RAW file format in the first embodiment;

FIG. 4 is a construction view that shows a process of a development operation of an image data in the RAW file format converted to a plurality of kinds of standardized file formats in the first embodiment;

FIG. 5 is a construction view that shows a process of a development operation of an image data in the RAW file format in the second embodiment;

FIG. 6 is a construction view that shows a process of a development operation of an image data in the RAW file format in the third embodiment;

FIG. 7 is a construction view that shows a process of a development operation of an image data in the RAW file format in the fourth embodiment;

FIG. 8 is a construction view that shows a process of a development operation of an image data in the RAW file format in the fifth embodiment; and

FIG. 9 is a construction view that shows a process of a development operation of an image data in the RAW file format in the sixth embodiment.

### DESCRIPTION OF THE PREFERRED EMBODIMENTS

The present invention is described below with reference to the embodiments shown in the drawings. A first embodiment is explained.

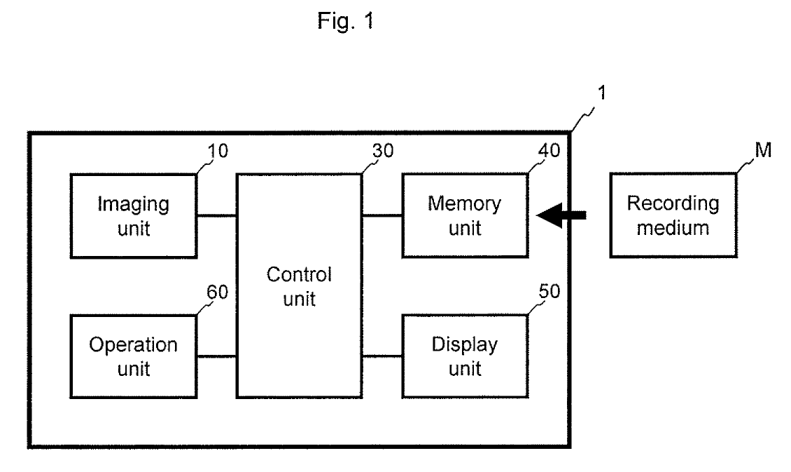

As shown in FIG. 1, in the first embodiment, a photographing apparatus comprises a imaging unit 10, a control unit 30, a memory unit 40, a display unit 50, and an operation unit 60. The photographing apparatus is a digital camera.

The imaging unit 10 has an imaging optical system, an imaging sensor, such as a CCD and a CMOS and other sensors, and a signal processing circuit. An optical image, that is, a projected subject image through the imaging optical system, projects onto an imaging surface of the imaging sensor. The imaging sensor converts the optical image to an electrical signal by a photoelectric conversion. After an electrical charge is accumulated in a predetermined time (an exposure time) at the imaging sensor, the electrical charge is read. The electrical signal that is based on the electrical charge, which is read, is output to the signal processing unit. The signal processing unit outputs the electrical signal of the subject, which is provided by the imaging operation as an imaging signal, to the control unit 30.

The control unit 30 is an apparatus that controls each part of the photographing apparatus 1, and contains, for example, a DSP (Digital Signal Processor) and a CPU (Central Processing Unit).

The control unit 30 outputs an imaging data that can be stored on a recording medium M on the basis of the imaging signal that is output from the imaging unit 10.

The memory unit 40 has a slot that the recording medium M is inserted into, and stores the imaging data, which is provided by the imaging operation, in a predetermined file format, such as the RAW file format, the JPEG file format, the TIFF file format, or other file formats.

The display unit 50 indicates an image that is provided by the imaging operation and an information regarding the operation.

The recording medium M is a removable medium, such as a SD card or other medium, that can read and write files by the photographing apparatus 1, a personal computer, or other suitable apparatus.

A first parameter is attached to a file that an image data in the RAW file format is stored in. The first parameter has a photography condition when a first imaging operation is performed. The photography condition has information regarding white balance (white balance gain), size of an image (width and height of the image), image quality (compression rate), color space, saturation, contrast, sharpness, optical black value (OB value), development gain (ISO speed adjustment value), color matrix, and tone table.

The image data in the RAW file format is converted to the image that can be observed at the display unit 50 by performing the image processing, taking into consideration the photography condition.

The white balance is a value set for the white balance adjustment, and has information regarding color temperature and color cast correction. Adjustment (Amendment) of the white balance is performed by multiplying a gain value by each RGB value.

The size of the image is the number of pixels in the image. The resizing operation is performed on the basis of the number of pixels,

The image quality (the compression rate) is a compression rate when image data is converted to a standardized file format, such as the JPEG file format, etc,

The color space is used for conversion of the color space (a 3×3 matrix calculation for RGB values, and a vector adjustment of the color space, etc.).

The saturation is used as a part of the parameter for color space, and as an adjustment of the deepness of color.

The contrast is used for the adjustment of hue, and is used as a parameter that selects the tone table.

The sharpness is used for edge smoothing correction against YCbCr values.

The optical black value is an offset value of the imaging sensor, including dark current that occurs in exposure time, and is used for adjusting an exposure zero level of the imaging sensor.

The development gain is used for adjusting white balance by ISO speed, when multiplying the gain value by each RGB value.

The color matrix is used as a part of the parameter of color space (coefficient of color correction).

The tone table is used for gamma correction, and for conversion of gradation.

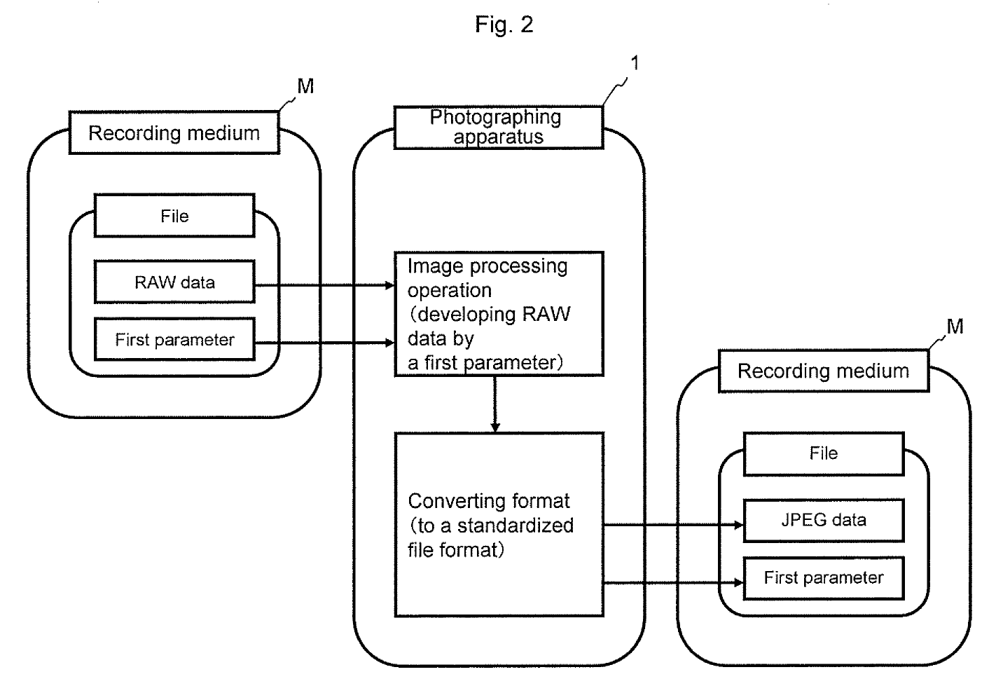

In the first embodiment, as shown in FIGS. 2 to 4, the image data in the RAW file format is developed by using the first parameter that is stored in the same file.

The operation unit 60 is used for ON/OFF control of a release switch (not depicted), command of a development operation by an operator, and selecting a file that stores the image data in the RAW file format for development.

The first imaging operation is performed by ON switching of the release switch.

The development operation does not link to the first imaging operation, and is performed corresponding to a command on the basis of an operation of the operation unit 60 by the operator.

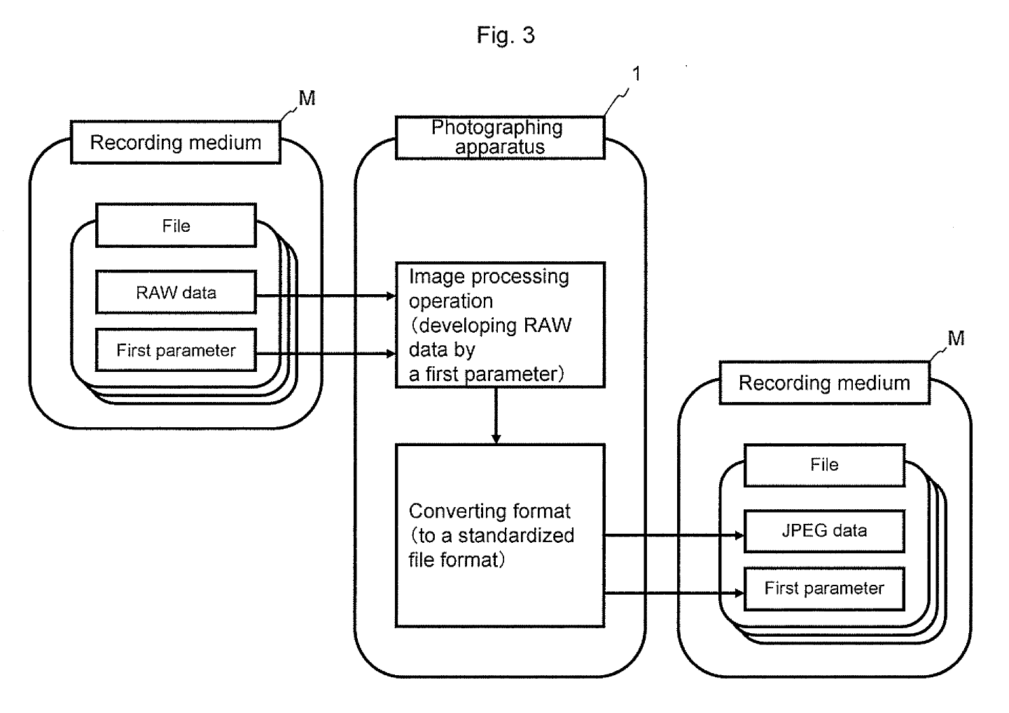

In addition, the command of the development operation may be carried out by specifying only a single file containing an image data in the RAW file format (see. FIG. 2), or it may also be carried out by specifying a plurality of files containing image data in the RAW file format (see FIG. 3).

The control unit 30 performs an image processing operation (a development operation) against the image data in the RAW file format in the first imaging operation that is stored in the file that is selected by the operator, by using the first parameter in the first imaging operation that is stored in the same file that is selected by the operator. By the image processing operation (the development operation), the image data in the RAW file format is converted to a standardized file format, such as the JPEG file format, the TIFF file format, etc., so that the image data that is converted to the standardized file format is stored in the recording medium M through the memory unit 40.

The file that stores the image data, which is developed and converted to the standardized file format, attaches the first parameter, which was used in the development operation.

The image processing operation (the development operation) is performed separately from the imaging operation in an arbitrary timing by the operator.

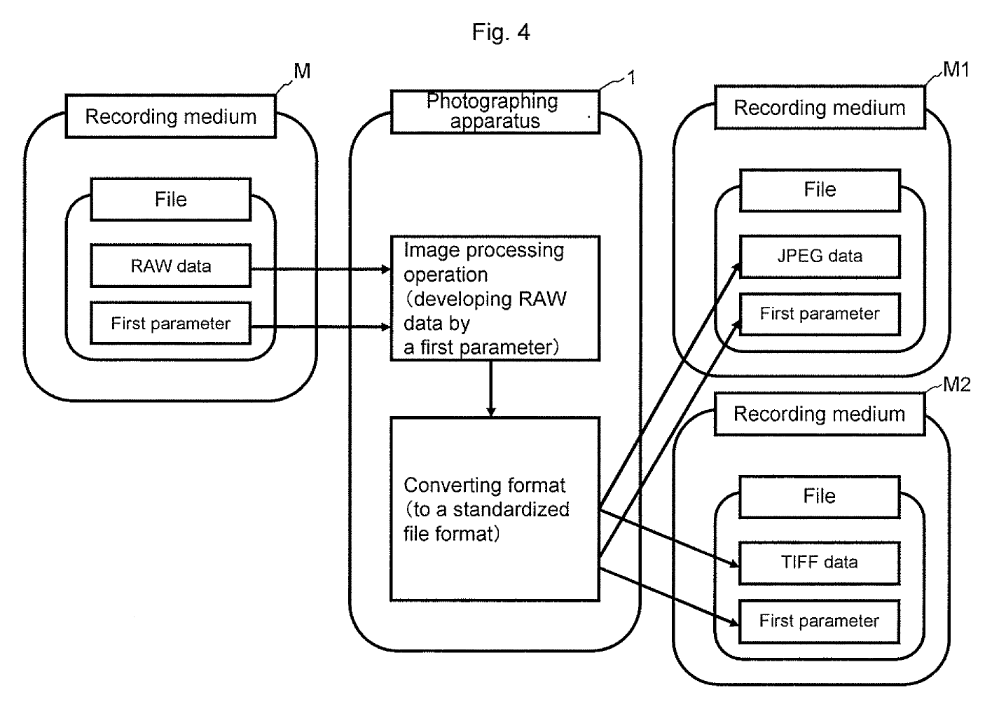

As shown in FIG. 4, not only one kind of conversion to the standardized file format is performed, but also a plurality of kinds of conversion to the standardized file format may be performed; for example, to the JPEG file format, the TIFF file format, or other file formats.

As shown in FIG. 2, the file that stores the image data, which is converted to the standardized file format, may be stored in the recording medium M, which stores the file storing the image data in the RAW file format. However, as shown in FIG. 4, the files that store the image data, which are converted to the standardized file formats, may be stored in the other recording media MI and M2.

The image data in the RAW file format can be edited by appropriate software that is installed on the personal computer or similar device. Further, a high quality image without deterioration of image quality by compression can be obtained, compared to the case in which the image data in a standardized file format, such as the JPEG file format, is edited.

An image corresponding to the image data in the RAW file format can not be seen on the display unit 50 before the development operation. The development operation of the image data in the RAW file format is needed to indicate the image data in the RAW file format as an image on the display unit 50. Because a personal computer with appropriate software installed is needed to perform the development operation, it is not appropriate if an immediate development operation (or immediate visual confirmation of the image) is needed after the imaging operation.

If the image data in the RAW file format and the image data in the standardized file format are stored at the same time, taking into account the case in which it is necessary to see the image immediately after the imaging operation, a storage field of the recording medium M is needlessly used (wasted), and the time required for saving is increased, so that a shutter chance may be missed.

Further, because the development operation using the appropriate software must be performed on a personal computer, the imaging condition of the photographing apparatus 1 may not be reflected accurately.

In the first embodiment, the development operation, which develops the image data in the RAW file format, is performed in an arbitrary timing after the first imaging operation in the photographing apparatus 1. Accordingly, the development operation can be performed even in a situation without the personal computer on which the appropriate software is installed.

Further, because only the file that stores the image data in the RAW file format and the file that stores the image data in the standardized file format necessary for the operator are stored on the recording medium M, the storage field of the recording medium M is not needlessly used (wasted).

Further, because the development operation is performed in an arbitrary timing different from the timing of the imaging operation, a time lag, such as that for a successive imaging operation, etc., is decreased, compared to the case in which the image data in the RAW file format and the image data in the standardized file format are both stored in the first imaging operation at the same time.

Further, because the development operation is performed by using the photographing apparatus 1, the imaging condition of the photographing apparatus 1 can be reflected accurately, compared to the case in which the development operation is performed on a personal computer.

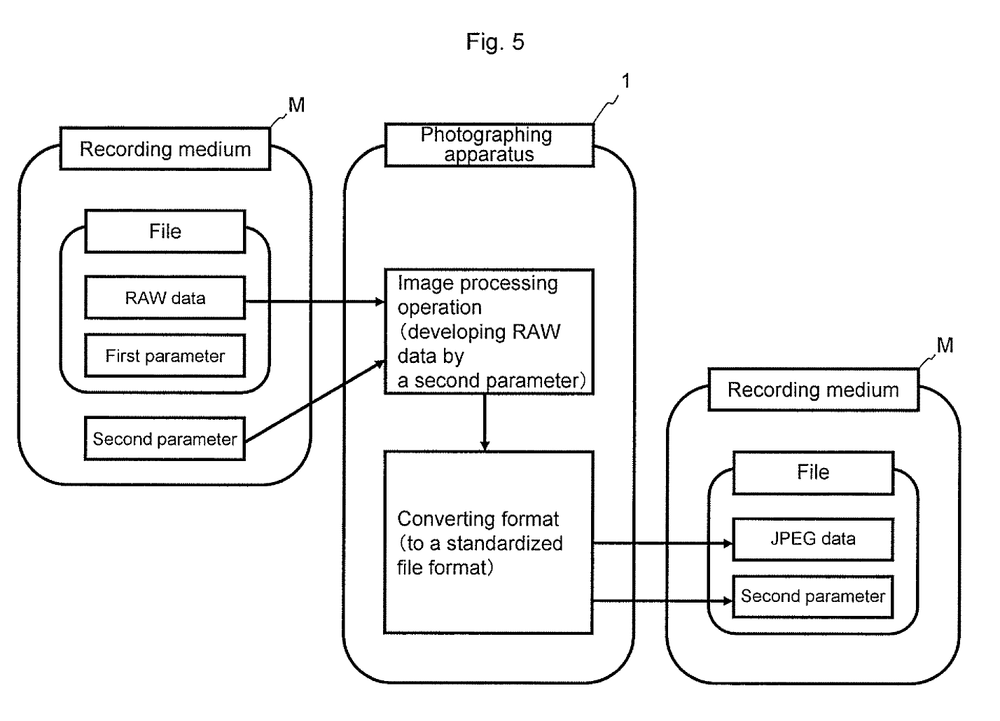

Next, the second embodiment is explained. As shown in FIGS. 2 to 4, in the first embodiment, the image data in the RAW file format is developed by using the first parameter, which is the parameter in the first imaging operation. As shown in FIG. 5, in the second embodiment, the image data in the RAW file format is developed by using a second parameter that is set differently from the first parameter in the first imaging operation.

The operation unit 60 is used for the ON/OFF control of a release switch (not depicted), the command of the development operation by the operator, selecting a file that stores the second parameter, and selecting a file that stores the image data in the RAW file format for development. The second parameter is a data file, such as a text file format set on the personal computer by the operator, that has the most suitable values for the development operation, and is stored on the recording medium M.

The control unit 30 performs the image processing operation (the development operation) against the image data in the RAW file format in the first imaging operation that is stored in the file that is selected by the operator by using the second parameter that is stored in the file that is selected by the operator and that is different from the file stored in the image data in the RAW file format. By the image processing operation (the development operation), the image data in the RAW file format is converted to a standardized file format, such as the JPEG file format, the TIFF file format, etc., so that the image data that is converted to the standardized file format is stored on the recording medium M through the memory unit 40.

The file that stores the image data, which is developed and is converted to the standardized file format, attaches the second parameter, which was used in the development operation.

The control unit 30 may perform two types of development operations against the image data in the RAW file format by using the first and second parameters, and the display unit may indicate two types of images based on the two types of development operations by using the first and second parameters, so that the image that was developed with the first parameter and the image that was developed with the second parameter can be compared.

The other constructions of the photographing apparatus 1 in the second embodiment are the same as those in the first embodiment.

In the second embodiment, the development operation can be performed by using a photography condition that is different from the photography condition for the first imaging operation. For example, even if the first imaging operation was performed in the day time, an image that has an atmosphere of dusk can be obtained by the development operation by using the second parameter.

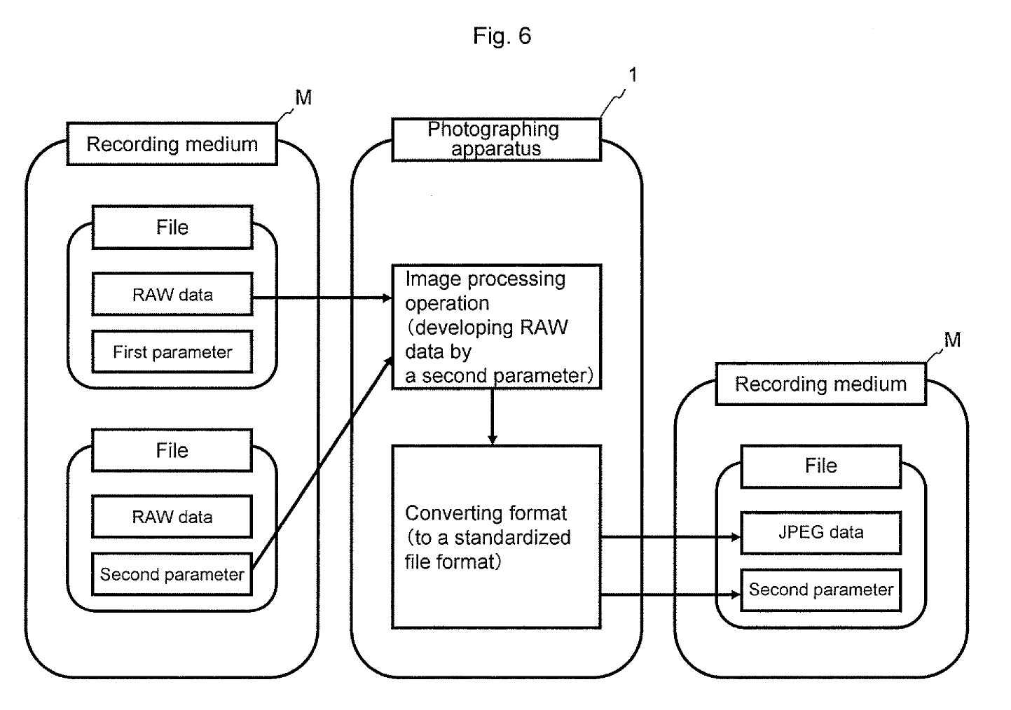

Next, the third embodiment is explained. In the second embodiment, the development operation is performed by using the second parameter, which is set by the operator. As shown in FIG. 6, in the third embodiment, a parameter that has a photography condition that is obtained in a second imaging operation different from the first imaging operation is used for the development operation as the second parameter.

The operation unit 60 is used for the ON/OFF control of a release switch (not depicted), the command of the development operation by the operator, selecting a file that stores image data in the RAW file format for use as the second parameter, and selecting a file that stores the image data in the RAW file format for development. The second parameter has a photography condition, when a second imaging operation, that is different from the first imaging operation that obtains the image data in the RAW file format for development, is performed. The second parameter is attached to a file where an image data in the RAW file format obtained in the second imaging operation is stored. The image data of the file that attaches the second parameter may be in a standardized file format, such as the JPEG file format.

The control unit 30 performs the image processing operation (the development operation) against the image data in the RAW file format in the first imaging operation that is stored in the file that is selected by the operator by using the second parameter that is attached to the selected file obtained in the second imaging operation. By the image processing operation (the development operation) the image data in the RAW file format is converted to a standardized file format, such as the JPEG file format, the TIFF file format, etc., so that the image data that is converted to the standardized file format is stored on the recording medium M through the memory unit 40.

The file that stores the image data, which is developed and is converted to the standardized file format, attaches the second parameter, which was used in the development operation.

A subject in the second imaging operation is a subject that can obtain values usable for the second parameter. The subject may be a standard image, such as a color chart.

In the case in which the image data that is used for the second parameter is in the RAW file format, the image data in the RAW file format may be developed by using the second parameter in advance, and the developed image and the values of the second parameter may be indicated on the display unit 50, so that the operator can confirm whether the developed image by the second parameter fits the operator's development image.

In the case in which the image data that is used for the second parameter is in a standardized file format, such as the JPEG file format, the image corresponding to the image data in the standardized file format and the values of the second parameter may be indicated on the display unit 50, so that the operator can confirm whether the image corresponding to the image data in the standardized file format fits the operator's development image.

The other constructions of the photographing apparatus 1 in the third embodiment are the same as those in the second embodiment.

In the third embodiment, the development operation can be performed by using a photography condition that is different from the photography condition in the first imaging operation, in the same way as in the second embodiment.

Further, the appropriate second parameter can be obtained by the operation of the photographing unit 1, unlike in the second embodiment.

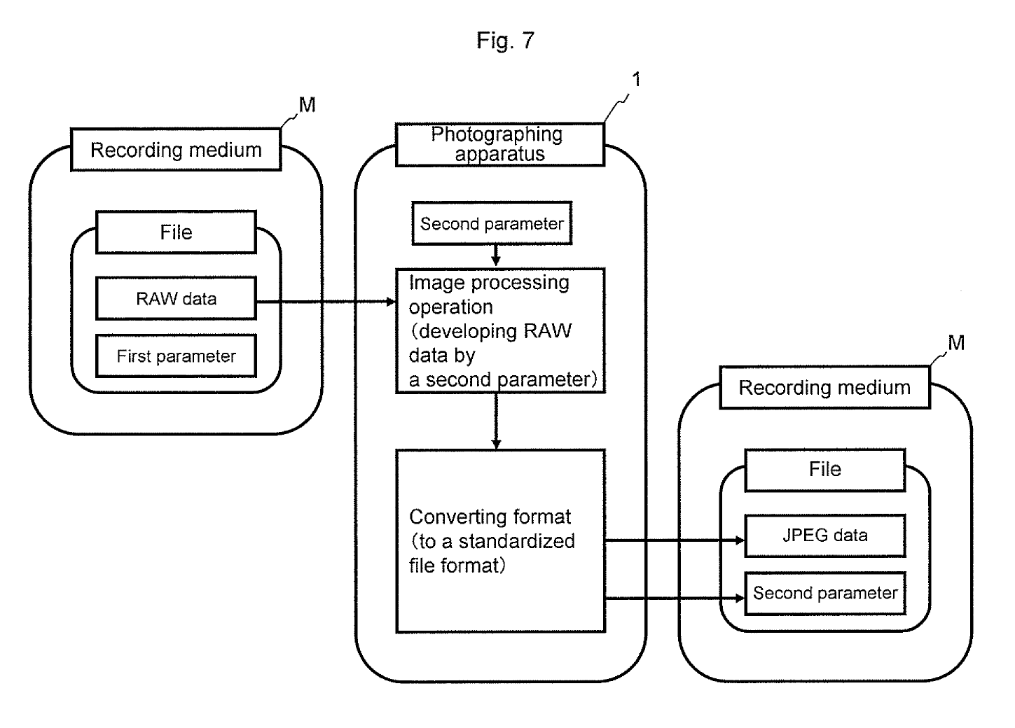

Next, the fourth embodiment is explained. In the second embodiment, the second parameter is stored in the recording medium M in the text file format set on the personal computer by the operator. As shown in FIG. 7, in the fourth embodiment, the second parameter is set by using the operation unit 60 of the photographing apparatus 1 in the development operation, and is used for development.

The operation unit 60 is used for the ON/OFF control of a release switch (not depicted), the command of the development operation by the operator, a setting of the second parameter, and selecting a file that stores the image data in the RAW file format for development.

The setting of the second parameter is performed by the operation of the operation unit 60. A condition of the setting of the second parameter is indicated on the display unit 50 in the image of a menu-setting screen. Values of the second parameter are appropriately set by the operator.

The control unit 30 performs the image processing operation (the development operation) against the image data in the RAW file format in the first imaging operation that is stored in the file that is selected by the operator by using the second parameter, which is set by the operator. By the image processing operation (the development operation), the image data in the RAW file format is converted to a standardized file format, such as the JPEG file format, the TIFF file format, etc., so that the image data that is converted to the standardized file format is stored on the recording medium M through the memory unit 40.

The file that stores the image data, which is developed and converted to the standardized file format, attaches the second parameter, which was used in the development operation.

The other constructions of the photographing apparatus 1 in the fourth embodiment are the same as those in the second embodiment.

In the fourth embodiment, the development operation can be performed by using a photography condition that is different from the photography condition in the first imaging operation, in the same way as in the second and third embodiments.

Further, the appropriate second parameter can be obtained by the operation of the photographing unit 1, in the same way as in the third embodiment.

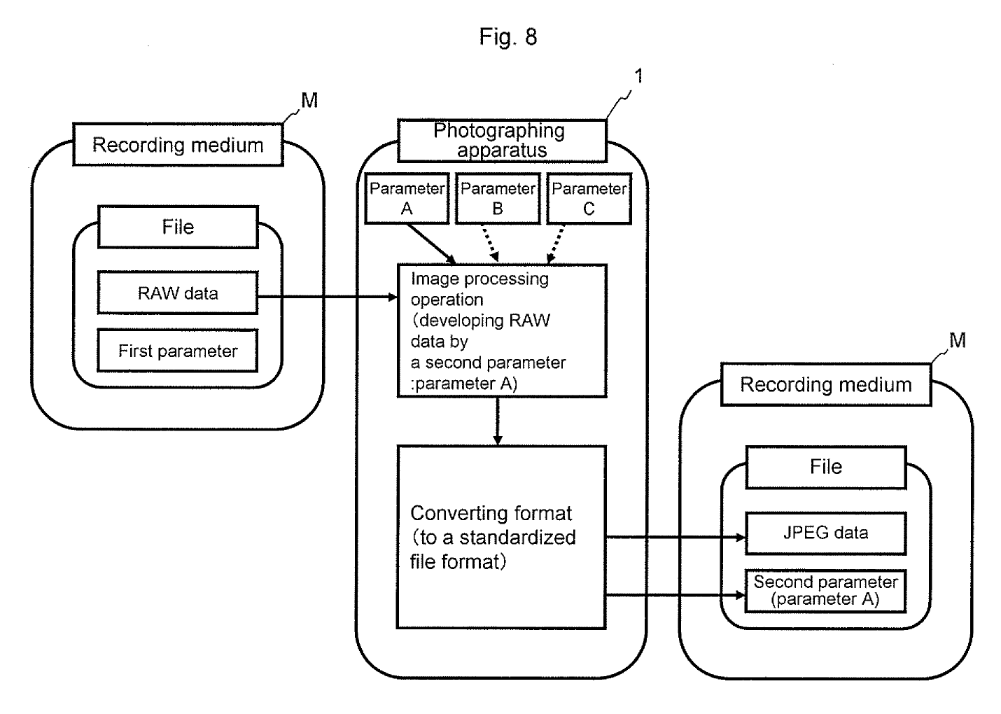

Next, the fifth embodiment is explained. In the fourth embodiment, the second parameter is set in the development operation. As shown in FIG. 8, in the fifth embodiment, one of the photography parameters that are set in the photographing apparatus 1 in advance is selected and used for development as the second parameter. The photographing parameters have photography conditions.

The operation unit 60 is used for the ON/OFF control of a release switch (not depicted), the command of the development operation by the operator, and selecting a file that stores the image data in the RAW file format for development.

A selection of the second parameter is performed by the operation of the operation unit 60; for example, selecting a dial of a picture mode set in the photographing apparatus 1. The photographing apparatus 1 has a plurality of kinds of photography parameters, each having different photography conditions from the other, and one of the photography parameters is selected and used as the second parameter by the operator.

FIG. 8 shows that the photographing apparatus 1 has three photography parameters, A, B, and C, and that the photography parameter A is selected as the second parameter by the operator.

The control unit 30 performs the image processing operation (the development operation) against the image data in the RAW file format in the first imaging operation that is stored in the file that is selected by the operator by using the photography parameter that is selected by the operator as the second parameter. By the image processing operation (the development operation), the image data in the RAW file format is converted to a standardized file format, such as the JPEG file format, the TIFF file format, etc., so that the image data that is converted to the standardized file format is stored on the recording medium M through the memory unit 40.

The file that stores the image data, which is developed and converted to the standardized file format, attaches the second parameter that was used in the development operation.

The other constructions of the photographing apparatus 1 in the fifth embodiment are the same as those in the fourth embodiment.

In the fifth embodiment, the development operation can be performed by using a photography condition that is different from the photography condition in the first imaging operation, in the same way as in the second, third, and fourth embodiments.

Further, the appropriate second parameter can be obtained by the operation of the photographing unit 1, in the same way as in the third and fourth embodiments.

Further, because pluralities of photography parameters are set in the photographing apparatus 1, as long as the operator selects one of the pluralities of photography parameters, the setting of the second parameter can be simplified.

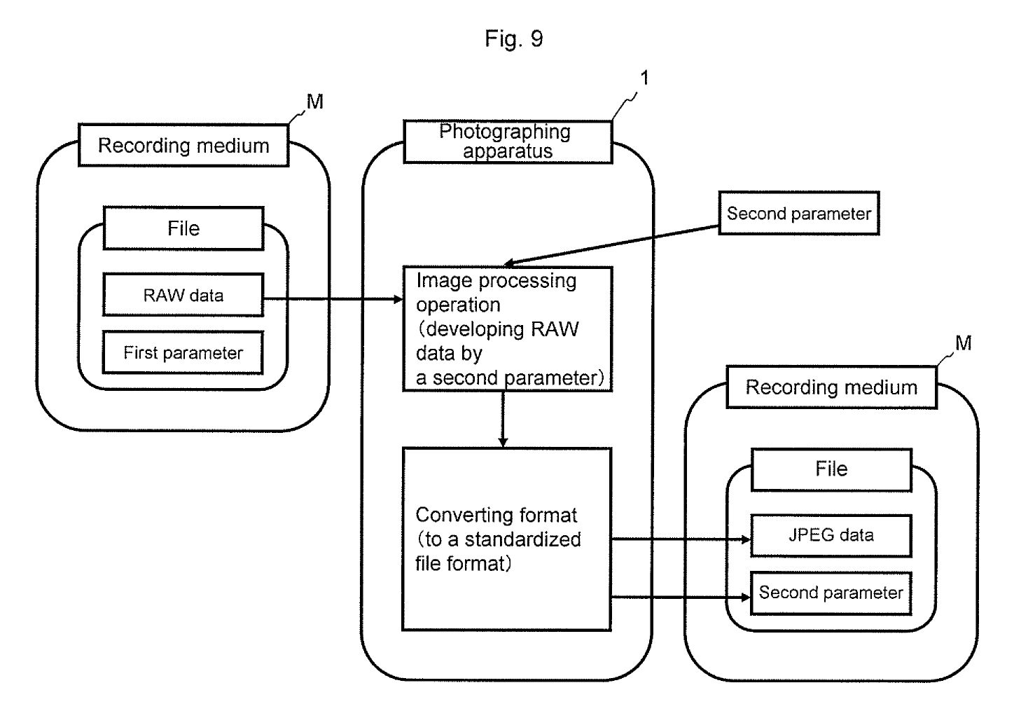

Next, the sixth embodiment is explained. In the fourth embodiment, the second parameter is set in the development operation. As shown in FIG. 9, in the sixth embodiment, a photography condition is obtained in the development operation by setting the ON state of the release switch (a third imaging operation), so that a photography parameter that has the photography condition is used for development as the second parameter.

The operation unit 60 is used for the ON/OFF control of a release switch (not depicted), the command of the development operation by the operator, and selecting a file that stores the image data in the RAW file format for development.

A subject in the third imaging operation is a subject that can obtain values usable for the second parameter. The subject may be a standard image, such as a color chart.

In the sixth embodiment, when the release switch is set to the ON state in the development operation, the third imaging operation for obtaining the photography condition is performed. A photography parameter that has the photography condition in the third imaging operation having information regarding a white balance and an optical black value is used for development as the second parameter.

It is desirable that the information regarding the white balance and the optical black value, which are obtained in the third imaging operation, is indicated on the through image on the display unit 50, so that the operator can confirm the information.

The control unit 30 performs the image processing operation (the development operation) against the image data in the RAW file format in the first imaging operation that is stored in the file that is selected by the operator by using the second parameter. By the image processing operation (the development operation), the image data in the RAW file format is converted to a standardized file format, such as the JPEG file format, the TIFF file format, etc., so that the image data that is converted to the standardized file format is stored on the recording medium M through the memory unit 40.

The file that stores the image data, which is developed and converted to the standardized file format, attaches the second parameter, which was used in the development operation.

The other constructions of the photographing apparatus 1 in the sixth embodiment are the same as those in the fourth embodiment.

In the sixth embodiment, the development operation can be performed by using a photography condition that is different from the photography condition in the first imaging operation, in the same way as in the second, third, fourth, and fifth embodiments.

Further, the appropriate second parameter can be obtained by the operation of the photographing unit 1, in the same way as in the third, fourth, and fifth embodiments.

Further, because the photography parameter that has the photography condition obtained in the third imaging operation, by setting the ON state of the release switch, is used for the development operation as the second parameter, the setting of the second parameter can be simplified.

Although these embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2005-236688 (filed on Aug. 17, 2005), which is expressly incorporated herein by reference, in its entirety.

1. A photographing apparatus, comprising:
an imaging unit that obtains an image signal by a first imaging operation;
a recording medium that stores an image data corresponding to said image signal in a RAW file format; and
a control unit that performs a development operation of said image data in said RAW file format, which is stored in said recording medium, on the basis of a parameter having a photography condition, and converts said image data to an image data in a standardized file format.

2. The photographing apparatus according to claim 1, wherein said image data that is converted to said standardized file format is stored in said recording medium.

3. The photographing apparatus according to claim 1 wherein a file that stores both said image data that is converted to said standardized file format and said parameter that is used for said development operation, is stored in said recording medium.

4. The photographing apparatus according to claim 1, wherein a file that stores both said image data in said RAW file format and a first parameter that has a photography condition in said first imaging operation, is stored in said recording medium.

5. The photographing apparatus according to claim 1, wherein said development operation is performed by a first parameter that has a photography condition in said first imaging operation.

6. The photographing apparatus according to claim 1, wherein said control unit performs said development operation and converts said image data in said RAW file format to a plurality of image data in said plurality of kinds of standardized file formats.

7. The photographing apparatus according to claim 6, wherein each of said plurality of files that store said plurality of image data in said plurality of kinds of standardized file formats, is stored on separate recording media.

8. The photographing apparatus according to claim 1, wherein said development operation is performed by a second parameter that has a photography condition set separately from a timing of said first imaging operation.

9. The photographing apparatus according to claim 8, wherein a file that stores said second parameter is stored on said recording medium.

10. The photographing apparatus according to claim 9, wherein a file stores said second parameter and an image data that is obtained in a second imaging operation being different from said first imaging operation.

11. The photographing apparatus according to claim 8, further comprising an operation unit;
wherein said control unit uses a photography parameter that has a photography condition set by an operation of said operation unit by an operator in said development operation as said second parameter.

12. The photographing apparatus according to claim 8, wherein said control unit has a plurality of kinds of photography parameters, and uses one of said plurality of kinds of photography parameters that is selected in said development operation as said second parameter.

13. The photographing apparatus according to claim 8, wherein said control unit uses a photography parameter that has a photography condition in a third imaging operation that is different from said first imaging operation in said development operation as said second parameter.

14. The photographing apparatus according to claim 1, wherein said photography condition has information regarding at least one of white balance, size of an image, image quality, color space, saturation, contrast, sharpness, optical black value, development gain, color matrix, or tone table.
